(19) United States
(12) Patent Application Publication
(10) Pub. No.: US 2004/0099432 A1
(43) Pub. Date: May 27, 2004

(54) Flanged service extension support

(76) Inventor: Harry I. Zimmerman, Los Angeles, CA (US)

Correspondence Address: Curtis L. Harrington, Suite 250, 6300 State University Drive, Long Beach, CA, 90815, US

(21) Appl. No.: 10/306,569

(22) Filed: Nov. 25, 2002

(51) Int. Cl. H02G 3/04

(52) U.S. Cl. 174/68.3

(57) ABSTRACT

A series of improved service extension supports have a large capacity profile which generally provides at least a partially restricted or variable restriction enclosure which facilitates the ability of the user to re-use the support, with either simple manipulation of the service extensions or optionally destructively or non-destructively secure the service extensions into the support. In a first embodiment, the support is a generally planar member having openings which can support either a commercially available grip tie or an integral grip tie structure. In a second embodiment, an open curved support is supported by a planar lower support having deep openings to enhance the ability of tie bands to more effectively secure a wide range of service extensions from few in number to many in number. A third embodiment includes a flexible snap lock encasement which is supported by a lower planar support and enables the user to snap a high capacity conduit open and shut to add and subtract wires from the closable conduit. A fourth embodiment includes an upwardly opening channel with a partial entry restriction and including a planar lower support. All of the lower planar supports in the various embodiments may include friction ridges for increased concentration of grip friction.

### FIELD OF THE INVENTION

The present invention relates to improvements in structures and methods for supporting and anchoring service extensions such as cables, wires and small conduit near walls, baseboards, floors and moldings.

### BACKGROUND OF THE INVENTION

In U.S. Pat. No. 5,514,834, entitled IMPROVED FLANGED CONDUIT AND INSULATION FOR ELECTRIC WIRES AND METHOD OF USE which issued on May 7, 1996; U.S. Pat. No. 5,877,451, entitled IMPROVED FLANGED CONDUIT AND INSULATION FOR ELECTRIC WIRES AND METHOD OF USE which issued March 2, 1999; and U.S. Pat. No. 6,055,789, entitled TOOL FOR INSTALLING IMPROVED FLANGED CONDUIT AND INSULATION FOR ELECTRIC WIRES which issued May 2, 2000; and U.S. Pat. No. 6,329,599 entitled FLANGED CONDUIT AND INSULATION FOR ELECTRIC WIRES AND METHOD OF USE which issued Dec. 11, 2001 all to Harry I. Zimmerman, which are incorporated herein by reference, disclose a number of mechanical orientations of flanged supports for supporting and organizing service extensions which include cables such as fiber optics and coaxials, as well as wires and small conduit. The structures provided a stylish and modern method of handling the service extensions commonly found in the home and office. Rather than the use of specialized structures which would otherwise harm walls, carpet, baseboards and the like, the structures provided the ability to garner support from thin spaces between the room structures normally found in an office or home, including a wall, a molding, a floor, a carpet, a rug, a baseboard, and other such structures.

The structures were typically provided as having a constant cross sectional shape and could be manufactured to hold wires, fiber optic cables and the like. Conversely, the structures were also amenable to being provided without pre-manufactured service extension structure so that existing service structures could be inserted or added and removed at any time.

With the existing use of computers and other office equipment, the need for collecting the multifarious service structures is growing rather than diminishing. The need is arising for structures which can adjustably hold many multiples of the bulky service extension structures of commonly available supports. What is needed are structures which garner the same dependence from interstitial meeting of elements among the existing wall, carpet, base board, and floor (to name a few) and which either have a high capacity for supporting service extensions or which have a variable capacity based upon need, which provides variable degrees of closure support and which and which can more easily allow selected ones of the service extensions to be selectably placed into or removed from a supported condition.

### SUMMARY OF THE INVENTION

A series of improved service extension supports have a large capacity profile which generally provides at least a partially restricted enclosure which facilitates the ability of the user to re-use the support, with either simple manipulation of the service extensions or optionally destructively or non-destructively secure the service extensions into the support.

In a first embodiment, the support is a generally planar member having openings which can support either a commercially available grip tie having discrete or infinitely adjustable ability or an integral grip tie structure for giving the ability to tightly or losely holding service extensions. In a second embodiment, an open curved support is supported by a planar lower support. The upper support has deep openings to enhance the ability of tie bands (elastic or grip tie or other) to more effectively secure a wide range of service extensions from few in number to many in number.

A third embodiment includes a flexible snap lock encasement which is supported by a lower planar support and enables the user to snap a high capacity conduit open and shut to add and subtract wires from the closable conduit. A fourth embodiment includes an upwardly opening channel with a partial entry restriction and including a planar lower support. All of the lower planar supports in the various embodiments may include friction ridges which may be affixed to the front or back (even though shown only on one side for simplicity of illustration) for increased concentration of grip friction. The ridges may be fixed or variable moving ridges with spring action.

### BRIEF DESCRIPTION OF THE DRAWINGS

The invention, its configuration, construction, and operation will be best further described in the following detailed description, taken in conjunction with the accompanying drawings in which:

FIG. 1 is a perspective view of a first embodiment of the service extension support having a generally planar member and shown with both an integral and a replaceable tie;

FIG. 2 is a persepective view of a second embodiment of a service extension support having an open curved support with deep openings to enable close forced gathering of the service extensions supported;

FIG. 3 is a perspective view of a third embodiment of a service extension support which includes a flexible snap lock encasement which is supported by a lower planar support; and

FIG. 4 is a fourth embodiment of a service extension support which enables the user to snap a high capacity conduit open and shut to add and subtract wires from the closable conduit.

### DETAILED DESCRIPTION OF THE PREFERRED EMBODIMENT

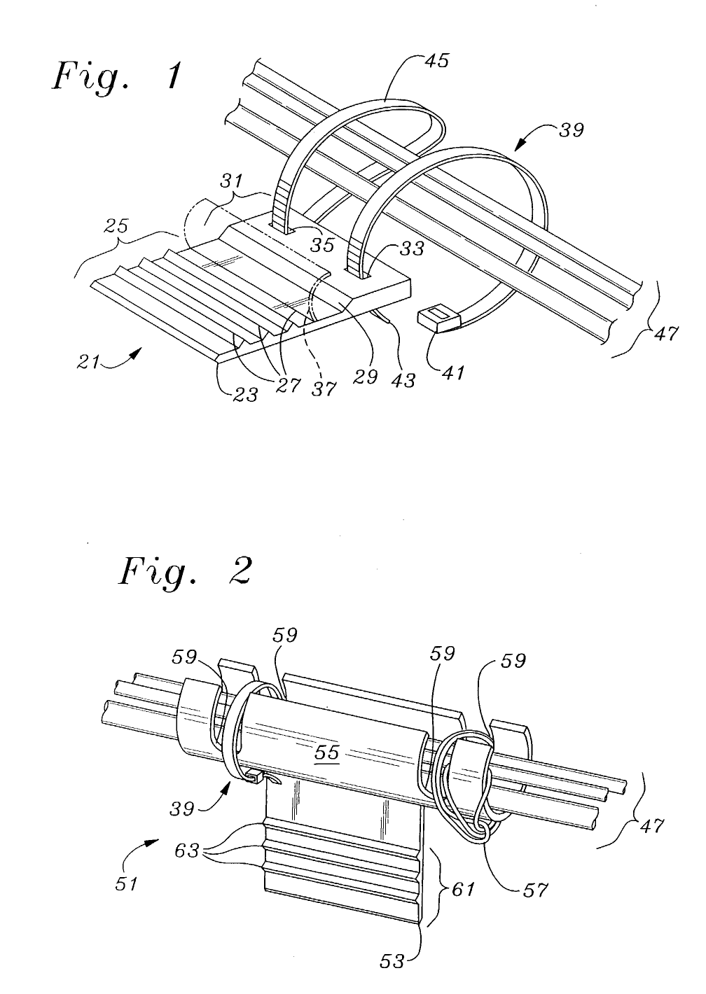

The embodiments will be show in isolation inasmuch as the prior structures referred to above illustrate how the spaces formed by interstitial meeting of elements among the existing wall, carpet, base board, and floor and the like can be accessed by a planar support. Referring to FIG. 1, a perspective view of a first embodiment of a service extension support 21 which includes a main body 23 having a first side and a second side and an insert mountable main extent 25 which includes a grouping of three spaced apart friction ridges 27. The service extension support 21 has an angled transition 29 to a upper extent 31 which is shown as having opening 33 and opening 35. An optional shelf member 37 may be present.

Opening 33 is illustrated in conjunction with a fastener such as a conventional grip tie 39 having a buckle end 41 which typically includes a ratchet or blade which operates to enable a belt end 43 to extend through the buckle end 41 in one direction only. Opening 35 has within it the ratchet or blade which operates enable a belt 45 made integrally with respect to the main body 23 to extend there through to thereby turn the whole of the main body 23 into a buckle end. Upon replacement, where a extension support 21 with through openings 33 are used exclusively, the conventional grip tie 39 can be replaced.

Where an extension support 21 with an integral belt 45 and opening 35 is used, the extension support 21 must be cut free and discarded and replaced with a new extension support 21. The extension support 21 is shown with a random grouping of service extension members 47. As can be seen, the grip tie 39 actually forms an abreviated length upper support in contrast to the longer main body 23.

FIG. 2 is a persepective view of a second embodiment seen as a service extension support 51 having an insert mountable support 53 having a first side and a second side and an open curved support 55 having a pair of curved side walls curved toward each other to somewhat restrict the opening at points along the width (or axial length) of open curved support 55. The open curved support 55 is has is wider than the insert mountable support 53, extending significantly beyond its dimension and which allows user access to the ends to place attachment members including another grip tie 39 seen at the left side of the open curved support 55 and a rubber band 57 seen at the right hand side of the open curved support 55, which has been looped around the service extension members 47. Both securing members engage at a pair of relatively deep openings 59 seen at the open curved support 55. The deep openings 59 enable the fastening members, such as twist ties, rubber band 57 and grip tie 39, for example, to more closely engage a smaller number of service extension members 47. As the open curved support 55 fills, the service extension members 47 can always be adjusted for a tight hold with the deep openings 59. As before an insert mountable main extent 61 includes spaced apart friction ridges 63.

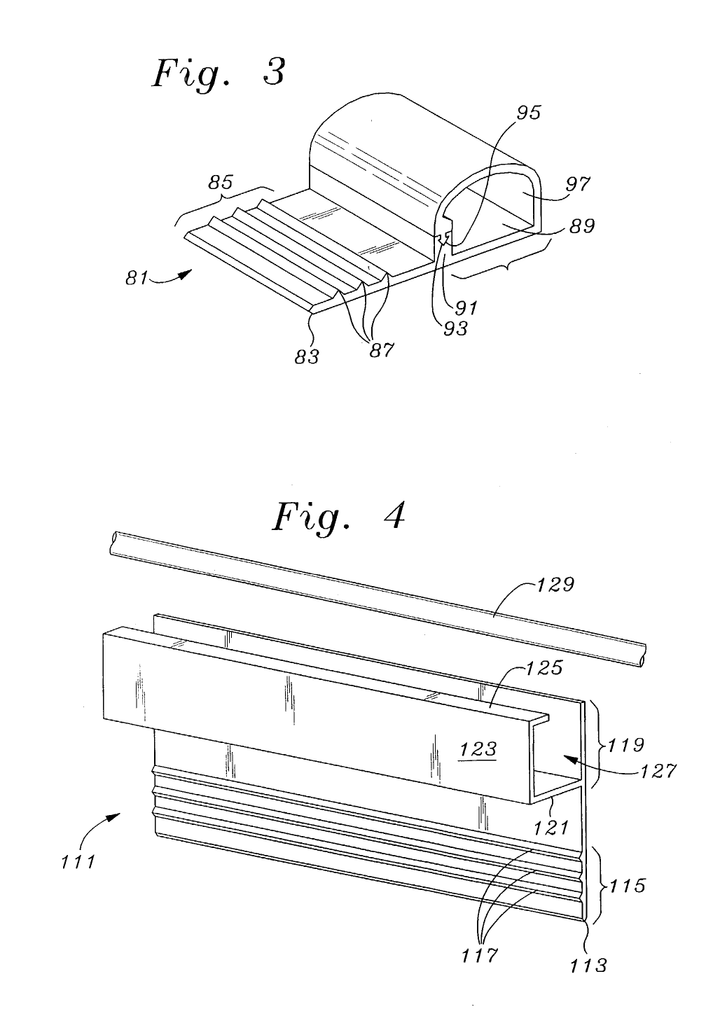

Referring to FIG. 3, a perspective view of a third embodiment is seen as a service extension support 81. Extension support 81 has a body 83 having a first side and a second side and having an insert mountable main extent 85 which includes a grouping of three spaced apart friction ridges 87. The service extension support 81 has an upper rear enclosure wall 89 which is generally parallel coextensive with the insert mountable main extent 85. A post 91 between the upper rear enclosure wall 89 and insert mountable main extent 85 includes a groove 93 for interfitting with an matching projection 95 on a side wall cover member 97. Side wall cover member 97 extends from its meeting point with the upper rear enclosure wall 89 into a gently arching cover shape before terminating at the laterally arrow shaped projection member 95.

When the arrow shaped projection member 95 is inserted into the groove 93, an upper stable housing is formed. Since the side wall cover member 97 and its arrow shaped projection member 95 can be snap removed from engagement into the groove 93 the formed opening can be accessed again and again to insert and remove service extension member 47 at will. The shape, materials and thickness of the side wall cover member 97 are selected so as to flexibly enable access without detracting from the structurally stable structure formed when the wall cover member 97 is closed.

Referring to FIG. 4, a perspective view of a fourth embodiment is seen as a service extension support 111 which enables the user to capture a number of service extension members 47 in a somewhat loose but at least captured manner and which includes the ability to provide an upper securing member. Extension support 111 has a body 113 having a first side and a second side and having an insert mountable main extent 115 which includes a grouping of three spaced apart friction ridges 117. The service extension support 119 has a upper rear wall 119, at least a portion of which is generally parallel coextensive with the insert mountable main extent 115. A bottom wall 121 extends outwardly from a point between the insert mountable main extent 115 and upper rear wall 119. A front wall 123 extends upwardly from the bottom wall 121.

To provide at least a limited degree of encasement, one of the front wall 123 and upper rear wall 119 will preferably have a single top wall 125 extending away from it to limit the upper access into a channel 127 formed by the upper rear wall 119, bottom wall 121 and front wall 123, and typically angled away as shown. In the alternative, a pair of abbreviated top walls 125 may be provided one atop each of the front wall 123 and upper rear wall 119, and extending toward each other. As can be further seen, FIG. 4 illustrates the top wall 125 extending from the front wall 123 and toward the upper rear wall 119.

Above the extension support 111 is seen an optional packing member 129 which is preferably either a lid or a deformable material which will fit through the opening to the channel 127 within the space between the top wall 125 and the top of the upper rear wall 119. When the packing member 129 is used, it will preferably have a color and texture matching that of the extension support 111 in order to hide the service extension members 47. To add new or remove unwanted service extension members 47, the packing member 129 is removed and then replaced.

While the present invention has been described in terms of a support for service extension members 47, as well as structures for both anchoring, supporting, securing, organizing, installing and replacing service extension members 47, one skilled in the art will realize that the structure and techniques of the present invention can be applied to many similar devices. The present invention may be applied in any situation where any compatible structures need to be supported.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A service extension member support comprising:
an upper support portion having an upper opening for supporting service extension members at least partially enclosed; and
an insert mountable main extent portion extending from said upper support portion and having a first side and a second side opposite said first side, said upper support extending from at least one of said first and second sides.

2. The service extension member support claim 1 wherein said partially enclosure of said upper support portion includes a pair of curved side walls curved toward each other at said upper opening.

3. The service extension member support claim 2 wherein said pair of curved side walls include relatively deep openings to enable a securing structure to closely hold a set of service extension members to said upper support.

4. The service extension member support claim 1 wherein said partially enclosure of said upper support portion includes at least an angled wall at least partially enclosing said upper opening.

5. The service extension member support claim 1 wherein said upper support portion is variably closable on said service extension members.

6. A service extension member support comprising:
an insert mountable main portion having a first side and a second side opposite said first side; and
an upper support portion having an upper rear enclosure wall which is generally coextensive with said insert mountable main portion and having a structure between said upper rear enclosure wall and said insert mountable main portion carrying a groove, and wherein said upper support portion further includes a side wall cover member extending from said upper rear enclosure wall and terminating in a projection member fittable into said groove to form a user closeable stable structure.

7. A service extension member support comprising:
a body having an insert mountable main extent and an upper extent including at least one aperture therethrough for supporting a fastener extending through said at least one aperture for supporting service extension members from said upper extent.

8. A service extension member support for installation adjacent one of a wall, a molding, a floor, a carpet, a rug and a baseboard and comprising:
an upper support portion having an upper opening for supporting service extension members; and
an insert mountable main extent portion extending away from and shorter than said upper support portion and having a first side for facing against at least one of said wall, said molding and said baseboard, and a second side opposite said first side.

9. The service extension member support as recited in claim 8 and further including an anchoring structure portion extending away from said first side of said insert mountable main extent, for engaging a surface of one of said wall, molding, floor, carpet, rug and baseboard.

10. The service extension member support claim 8 wherein said upper support portion is variably closable on said service extension members.

11. A service extension member support for installation adjacent one of a wall, a molding, a floor, a carpet, a rug and a baseboard and comprising:
an upper support portion having an upper opening for supporting service extension members; and
an insert mountable main extent portion extending away from and longer than said upper support portion and having a first side for facing against at least one of said wall, said molding and said baseboard, and a second side opposite said first side.

12. The service extension member support as recited in claim 11 and further including an anchoring structure portion extending away from said first side of said insert mountable main extent, for engaging a surface of one of said wall, molding, floor, carpet, rug and baseboard.

13. A service extension member support for installation adjacent one of a wall, a molding, a floor, a carpet, a rug and a baseboard and comprising:
an upper support portion having an upper opening for supporting service extension members and which is variably closable on said service extension members; and
an insert mountable main extent portion extending away from said upper support portion and having a first side for facing against at least one of said wall, said molding and said baseboard, and a second side opposite said first side.
